(19) United States
(12) Patent Application Publication
(10) Pub. No.: US 2024/0205241 A1
(43) Pub. Date: Jun. 20, 2024

(54) SELF-LEARNING-BASED INTRUSION DETECTION APPARATUS AND METHOD

(71) Applicant: ELECTRONICS AND TELECOMMUNICATIONS RESEARCH INSTITUTE, Daejeon (KR)

(72) Inventors: Byung-Ho CHUNG, Sejong-si (KR); Hyeok-Chan KWON, Daejeon (KR)

(73) Assignee: ELECTRONICS AND TELECOMMUNICATIONS RESEARCH INSTITUTE, Daejeon (KR)

(21) Appl. No.: 18/453,703

(22) Filed: Aug. 22, 2023

(30) Foreign Application Priority Data
Dec. 20, 2022 (KR) 10-2022-0178880

(51) Int. Cl. H04L 9/40

(52) U.S. Cl. CPC H04L 63/1416; H04L 63/1425

(57) ABSTRACT

Disclosed herein are self-learning-based intrusion detection apparatus and method. The self-learning-based intrusion detection apparatus includes memory configured to store at least one program, and a processor configured to execute the program, wherein the program is configured to perform detecting an anomaly behavior in network traffic based on a first detection model, and as a self-learning event is published, generating a second detection model through self-learning in parallel with detecting the anomaly behavior, and wherein the program is configured to perform, as the second detection model is generated, in detecting the anomaly behavior, replacing the first detection model with the second detection model, and thereafter detecting the anomaly behavior in the network traffic.

### CROSS REFERENCE TO RELATED APPLICATION

This application claims the benefit of Korean Patent Application No. 10-2022-0178880, filed Dec. 20, 2022, which is hereby incorporated by reference in its entirety into this application.

### BACKGROUND OF THE INVENTION

### 1. Technical Field

The following embodiments relate to technology for detecting intrusion for malicious attacks made over a network.

### 2. Description of the Related Art

Technical schemes for detecting malicious attacks on a network include two schemes, that is, a signature- or rule-based detection scheme and a behavior-based detection scheme.

Of the detection schemes, the signature-based detection scheme may be effective in well-known attack detection with the use of a well-known detection signature, but is disadvantageous in that it is vulnerable to rule-evading variant attacks or unknown attacks with signatures that are not well-known.

Further, with the development of recent deep-learning technology, research into technology in which artificial intelligence (AI) technology is applied to the behavior-based detection scheme has attracted keen attention. However, in the behavior-based detection scheme, there are technical issues regarding how to define and detect attack behavior that various types of malware exhibit on the network during their operations.

In order to solve these issues, research into technology which find low-dimensional behavior features using various types of machine-learning techniques such a random forest algorithm or an auto-encoder and which develop deep-learning detection models with high detection performance, such as a Recurrent Neural Network (RNN), a Gated Recurrent Unit (GRU), Long Short Term Memory (LSTM) and Generative Adversarial Network (GAN), using various types of found behavior features has been actively conducted.

However, the problem of learning data (training data) becomes an obstacle to the development of such a deep-learning detection model. That is, when another type of new attack (i.e., a new malware attack) that is not used during a learning process intrudes into the network even though features and a deep-learning detection model that are effective in detecting a specific behavior are developed, the detection performance of the deep-learning detection model is deteriorated, thus inevitably increasing a detection error rate. The reason for this is that it is impossible to secure all-round learning data including the features of all known or unknown attack behaviors, and in addition, the characteristics of data of continuously appearing new attacks also change depending on the situation.

Further, when a developed deep-learning detection model is commercialized and operated in an actual environment, there is a need to improve the model due to performance deterioration, thus resulting in cost problems such as the maintenance time of the deep-learning detection model and personnel expenses thereof. That is, the reason for this is that an engineer needs to intervene in the development of a new learning model and in the replacement of an existing learning model installed in the corresponding device.

Intrusion detection systems using machine learning (Artificial Intelligence: AI) are problematic in that, with the change of an operating environment and the behavioral features of a target, a situation in which performance is deteriorated occurs, and the improvement of performance of the corresponding detection model is required, thus causing the problem of cost increase attributable to maintenance.

The reason for this is that an engineer needs to intervene in the development of a new learning model and in the replacement of an existing learning model installed in the corresponding device.

For these reasons, although a lot of research into the behavior-based intrusion detection technique has been conducted, it is difficult to find commercial products embedded in an actual network device or deployed in a cloud system or a control server. Although there is any commercial product, an index for determining the effect of the commercial product, such as detection performance, is not open to the public due to the above reasons.

Therefore, in order to solve the above-described problems, there is required a method for minimizing the cost of learning model improvements essentially needed in a process of improving, operating, and maintaining an intrusion detection model.

### SUMMARY OF THE INVENTION

An embodiment is intended to minimize cost, such as manpower and time, essentially needed in a process of improving, operating, and maintaining an intrusion detection model.

In accordance with an aspect, there is provided a self-learning-based intrusion detection apparatus, including memory configured to store at least one program, and a processor configured to execute the program, wherein the program is configured to perform detecting an anomaly behavior in network traffic based on a first detection model, and as a self-learning event is published, generating a second detection model through self-learning in parallel with detecting the anomaly behavior, and wherein the program is configured to perform, as the second detection model is generated, in detecting the anomaly behavior, replacing the first detection model with the second detection model, and thereafter detecting the anomaly behavior in the network traffic.

The self-learning-based intrusion detection apparatus may further include an in-memory database (DB) including a function of a Publish/Subscribe (Pub/Sub) server of performing event channel subscribe and event publish messaging, wherein a first process subscribes to a certain event channel in the Pub/Sub server and thereafter waits in a queue of the event channel, and wherein a second process transmits event data to the queue of the corresponding event channel as a certain event is published.

The program may be configured to further perform in detecting the anomaly behavior, converting network input data into NetFlow data, extracting detection-purpose behavior feature data from the NetFlow data, and predicting whether a behavior in the extracted behavior feature data is anomalous, based on the first detection model.

The program may be configured to further perform, in detecting the anomaly behavior, detecting a signature in the NetFlow data.

The program may be configured to further perform, in generating the second detection model, auto-labeling the NetFlow data as to whether the NetFlow data is normal or abnormal as a self-learning mode starts, generating learning-purpose behavior feature data of auto-labeled NetFlow data, and generating the second detection model by performing learning based on the learning-purpose behavior feature data.

The program may be configured to further perform, in auto-labeling the NetFlow data, subscribing to a self-learning mode channel in the Pub/Sub server and waiting in a queue, when a self-learning mode event is published, obtaining input data from the queue, generating auto-labeled learning data using the NetFlow data, retrieved from the in-memory DB based on the input data, and a signature detection log, storing the auto-labeled learning data in the in-memory DB, and assigning a storage position and search information thereof to output data, and publishing a self-learning feature generation event including the output data.

The input data is defined as variables including information of whether an operating state of the self-learning mode starts or stops, a volume of learning data, and a collection period of learning data.

The program may be configured to further perform, in generating the learning-purpose behavior feature data, subscribing to a self-learning feature generation channel and waiting in a queue, when a self-learning feature generation event is published, obtaining input data from the queue, generating a behavior feature dataset from auto-labeled learning data retrieved from the in-memory database based on the input data, storing the generated behavior feature dataset in the in-memory database, and assigning a storage position and search information thereof as output data, and publishing a model generation event including the output data.

The program may be configured to further perform, in generating the second detection model, subscribing to a model generation channel and waiting in a queue, as a model generation event is published, obtaining data input to the queue, generating self-learning input data by preprocessing a learning-purpose behavior feature dataset retrieved from the in-memory DB based on the input data, and generating a new second detection model using a learning algorithm, storing the generated second detection model and allocating a storage position thereof and parameter information required for use of the model to output data, and publishing a model change event including output data.

The program may be configured to further perform, in predicting whether the behavior is anomalous, measuring a self-learning score based on at least one of accuracy of a detection result based on the first detection model or a false positive rate, or a combination thereof, and when the self-learning score is greater than a preset threshold value, publishing a learning mode event.

The self-learning mode event may be published from an external control/log analysis system.

The program may be configured to further perform, in predicting whether the behavior is anomalous, subscribing to a model change channel and waiting in a queue, as a model change event is published, obtaining data input to the queue, extracting the second detection model using information included in the input data, and replacing the first detection model with the second detection model, and publishing a self-learning mode event by assigning learning stop to the output data.

In accordance with another aspect, there is provided a self-learning-based intrusion detection method, including detecting an anomaly behavior in network traffic based on a first detection model, and as a self-learning event is published, generating a second detection model through self-learning in parallel with detecting the anomaly behavior, wherein detecting the anomaly behavior includes, as the second detection model is generated, replacing the first detection model with the second detection model, and thereafter detecting the anomaly behavior in the network traffic.

Detecting the anomaly behavior may include converting network input data into NetFlow data, extracting detection-purpose behavior feature data from the NetFlow data, and predicting whether a behavior in the extracted behavior feature data is anomalous, based on the first detection model.

Detecting the anomaly behavior may further include detecting a signature of the NetFlow data.

Generating the second detection model may include auto-labeling the NetFlow data as to whether the NetFlow data is normal or abnormal as a self-learning mode starts, generating learning-purpose behavior feature data of auto-labeled NetFlow data, and generating the second detection model by performing learning based on the learning-purpose behavior feature data.

Predicting whether the behavior is anomalous may include measuring a self-learning score based on at least one of accuracy of a detection result based on the first detection model or a false positive rate, or a combination thereof, and when the self-learning score is greater than a preset threshold value, starting the self-learning mode.

The start of the self-learning mode may be performed in compliance with a command from a manager through an external control/analysis system.

Predicting whether the behavior is anomalous may further include as the second detection model is generated, replacing the first detection model with the second detection model, and stopping the self-learning mode.

In accordance with a further aspect, there is provided a self-learning-based intrusion detection apparatus, including an in-memory database (DB) including a function of a Publish/Subscribe (Pub/Sub) server of performing event channel subscribe and event publish messaging, a memory configured to store at least one program, and a processor configured to execute the program, wherein the program is configured to perform, in an anomaly behavior detection mode, converting network input data into NetFlow data, detecting a signature of the NetFlow data, extracting detection-purpose behavior feature data from the NetFlow data, and predicting whether a behavior in the extracted behavior feature data is anomalous, based on a first detection model, in a self-learning mode, as the self-learning mode starts, auto-labeling the NetFlow data as to whether the NetFlow data is normal or abnormal, generating learning-purpose behavior feature data of auto-labeled NetFlow data, and generating a second detection model by performing learning based on the learning-purpose behavior feature data, wherein the self-learning mode and the anomaly behavior detection mode are performed in parallel for interconnection with the Pub/Sub server, as the second detection model is generated, the first detection model is replaced with the second detection model.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a schematic block configuration diagram of a self-learning-based intrusion detection apparatus according to an embodiment;

FIG. 2 is a diagram for explaining an example of event channel subscription and event publication between processes in a self-learning-based intrusion detection apparatus according to an embodiment;

FIG. 3 is a conceptual diagram for explaining state transitions between the processes of a self-learning-based intrusion detection apparatus according to an embodiment;

FIG. 4 is a diagram for defining publish/subscribe (Pub/Sub) event channels subscribed by the processes of a self-learning-based intrusion detection apparatus according to an embodiment;

FIG. 5 is a diagram for explaining the state transition process of the self-learning-based intrusion detection apparatus according to an embodiment;

FIG. 6 is a flowchart for explaining a learning data auto-labeling process according to an embodiment;

FIG. 7 is a flowchart for explaining a self-learning-purpose behavior feature generation process according to an embodiment;

FIG. 8 is a flowchart for explaining an anomaly behavior learning and model generation process according to an embodiment;

FIG. 9 is a flowchart for explaining an anomaly behavior detection and self-learning start process according to an embodiment;

FIG. 10 is a flowchart for explaining a self-learning start process performed by a control/log analysis system according to an embodiment;

FIG. 11 is a flowchart for explaining a detection model replacement and self-learning stop process according to an embodiment; and

FIG. 12 is a diagram illustrating the configuration of a computer system according to an embodiment.

### DESCRIPTION OF THE PREFERRED EMBODIMENTS

Advantages and features of the present disclosure and methods for achieving the same will be clarified with reference to embodiments described later in detail together with the accompanying drawings. However, the present disclosure is capable of being implemented in various forms, and is not limited to the embodiments described later, and these embodiments are provided so that this disclosure will be thorough and complete and will fully convey the scope of the present disclosure to those skilled in the art. The present disclosure should be defined by the scope of the accompanying claims. The same reference numerals are used to designate the same components throughout the specification.

It will be understood that, although the terms “first” and “second” may be used herein to describe various components, these components are not limited by these terms. These terms are only used to distinguish one component from another component. Therefore, it will be apparent that a first component, which will be described below, may alternatively be a second component without departing from the technical spirit of the present disclosure.

The terms used in the present specification are merely used to describe embodiments, and are not intended to limit the present disclosure. In the present specification, a singular expression includes the plural sense unless a description to the contrary is specifically made in context. It should be understood that the term “comprises” or “comprising” used in the specification implies that a described component or step is not intended to exclude the possibility that one or more other components or steps will be present or added.

Unless differently defined, all terms used in the present specification can be construed as having the same meanings as terms generally understood by those skilled in the art to which the present disclosure pertains. Further, terms defined in generally used dictionaries are not to be interpreted as having ideal or excessively formal meanings unless they are definitely defined in the present specification.

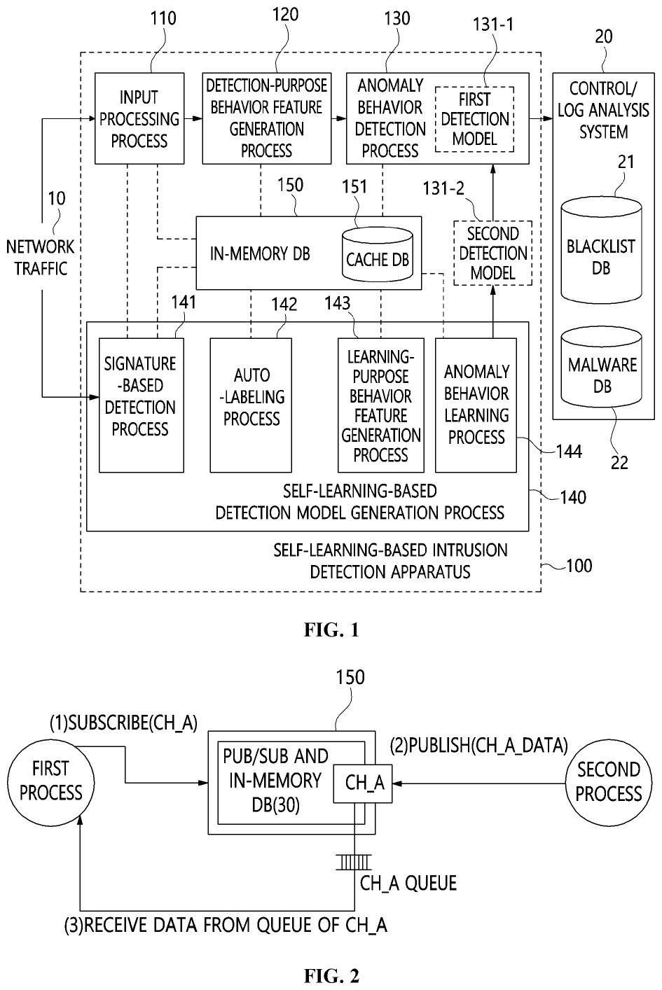

FIG. 1 is a schematic block configuration diagram of a self-learning-based intrusion detection apparatus according to an embodiment.

Referring to FIG. 1, a self-learning-based intrusion detection apparatus 100 according to an embodiment may mainly include an input processing process 110, a detection-purpose behavior feature generation process 120, an anomaly behavior detection process 130, and a self-learning-based detection model generation process 140.

Here, the self-learning-based detection model generation process 140 may include a signature-based detection process 141, an auto-labeling process 142, a learning-purpose behavior feature generation process 143, and an anomaly behavior learning process 144.

The self-learning-based intrusion detection apparatus 100 according to the embodiment may further include an in-memory database (DB) 150. Here, the in-memory DB 150 may include a Publish/Subscribe (Pub/Sub) server function for processing publish/subscribe messaging for event channels.

Therefore, the self-learning-based intrusion detection apparatus 100 may include multiple processes 110 to 140, which may control a learning sequence while communicating with each other using the in-memory DB 150. Therefore, processes 141 to 144 included in the self-learning-based detection model generation process 140 may be operated when a publish/subscribe message communication protocol for each event channel is added to the in-memory DB 150.

The self-learning-based intrusion detection apparatus 100 according to the embodiment may be operated in two operating modes, that is, a detection mode and a self-learning mode.

First, the detection mode is a mode in which, as time-series streaming network data is input, an anomaly behavior is repeatedly detected based on a previously generated first detection model 131-1. Here, the input processing process 110, the detection-purpose behavior feature generation process 120, and the anomaly behavior detection process 130 may be operated.

Next, in the self-learning mode, the operation of the self-learning-based detection model generation process 140 may be added to the above-described detection mode. That is, as a self-learning mode event occurs while the self-learning-based intrusion detection apparatus 100 is operating in the detection mode, self-learning may be performed by the self-learning-based detection model generation process 140, and then a second detection model 131-2 may be generated. Then, the anomaly behavior detection process 130 may continuously drive the detection mode by replacing the existing first detection model 131 with the new second detection model 131-2 at runtime. Thereafter, the self-learning mode may be stopped.

That is, while continuously operating in the detection mode without interruption after driving starts, the self-learning-based intrusion detection apparatus 100 according to the embodiment may update the detection model while executing the self-learning mode in parallel with the detection mode only during a self-learning event period.

Then, the components of the self-learning-based intrusion detection apparatus 100 according to an embodiment will be described in detail below.

First, the in-memory DB 150, which includes a Pub/Sub server function of processing publish/subscribe messaging for event channels, may provide functions of storing, managing, and sharing intrusion detection-related data, generated by the processes of the self-learning-based intrusion detection apparatus 100 according to the embodiment, and a message communication function between the processes.

Here, data that is input to and output from the in-memory DB 150 may comply with a JavaScript Object Notation (JSON) format.

A cache DB 151 may be an in-memory archive DB, in which behavior feature data, which is previously detected and abnormally labeled, and abnormal behavior feature data, which is not actual operating environment data, but is collected in the vulnerability/malware DB 22 of a control/log analysis system 20, are stored. These pieces of behavior feature data may be used as abnormal data in future self-learning.

Here, as an example of the cache DB 151 including both the Pub/Sub server function and the in-memory DB function, there may be an open source Remote Dictionary Server (Redis) DB.

The input processing process 110 converts network input data into NetFlow-type data and stores the NetFlow-type data in the in-memory DB 150.

Network input data 10 may be network traffic in the actual operating environment, which is received on the network including the Ethernet or the like. The following Table 1 shows an example of network input data, which is input data.

TABLE 1

StartTime,Dur,Proto,SrcAddr,Sport,Dir,DstAddr,Dport,State,sTos,dTos,TotP
kts,SrcPkts,TotBytes,SrcBytes,Load,SrcLoad,SIntPkt,DIntPkt
2018/06/09
00:10:16.064127,9.524092999999999,udp,192.168.122.103,49303.0, −
>,239.255.0.1,7400.0,INT,0.0,,23,23,4918,4918,3952.0825200000004,3952.
0825200000004,432.913313,,

The following Table 2 shows NetFlow data stored in the in-memory DB 150 in the input processing process 110 and is an example of a JSON data format.

TABLE 2
{“ts”: “1667450568044.537”, “dur”: “0.000000”, “saddr”: “10.20.210.10”,
“sport”: “123”, “daddr”: “10.30.213.244”, “dport”: “123”, “proto”: “udp”,
“origstate”: “INT”, “state”: “NotEstablished”, “pkts”: “1”, “allbytes”: “90”,
“spkts”: “1”, “sbytes”: “90”, “appproto”: “”, “label”: “normal”,
“module_labels”: {“flowalerts-long-connection”: “normal”},
“snort_severity”: “”, “snort_classType”: “”, “snort_detectionType”: “”,
“snort_msg”: “”, “snort_detectionTime”: “”, “suricata_severity”: “”,
“suricata_classType”: “”, “suricata_detectionType”: “”, “suricata_msg”: “”,
“suricata_detectionTime”: “”, “medips_classType”: “”,
“medips_detectionType”: “”, “medips_msg”: “”, “confidence”: “”,
“threatLevel”: “”, “classType”: “”, “detectionType”: “”}

Next, the signature-based detection process 141 may realize a detection function process using an open solution such as existing Snort or Suricata, or using one or more solutions previously held by an institution that operates a detection system.

The signature-based detection process 141 according to an embodiment may be utilized to maximally label anomaly data by detecting the signature of the network input data. The reason for this is that it is impossible to determine whether the network input data is normal data or anomaly data associated with a malware attack behavior.

The following Table 3 shows an example of a signature detection log using Snort that is the output data of the signature-based detection process 141.

TABLE 3
{“timestamp” : “06/09-03:20:10.714054”, “iface” : “wannacry.pcapng”, “src_addr” :
“192.168.122.100”, “src_port” : 56808, “dst_addr” : “8.8.4.4”, “dst_port” : 53, “ dst_port
” : “UDP”, “action” : “allow”, “msg” : “INDICATOR COMPROMISE DNS request for
known malware sinkhole domain iuqerfsodp9ifjaposdfjhgosurijfaewrwergwea.com -
WannaCry”, “priority” : 1, “class” : “A Network Trojan was detected”, “sid” : 44037 }

The auto-labeling process 142 automatically attaches labels to NetFlow data received by the input processing process 110. The NetFlow data automatically labeled in this way is stored in the in-memory DB 150.

The detection-purpose behavior feature generation process 120 and the learning-purpose behavior feature generation process 143 may generate behavior feature data by receiving data auto-labeled by the auto-labeling process 142 as input.

Here, the detection-purpose behavior feature generation process 120 and the learning-purpose behavior feature generation process 143 may use the same algorithm or different algorithms.

Here, the detection-purpose behavior feature generation process 120 may generate behavior feature data for one flow. On the other hand, the learning-purpose behavior feature generation process 143 may generate behavior feature data by selecting an amount of data required for self-learning, and may generate behavior feature data for the corresponding data.

The behavior feature data generated by the detection-purpose behavior feature generation process 120 and the learning-purpose behavior feature generation process 143 may be stored in the in-memory DB 150. The following Table 4 shows an example of the behavior feature data.

TABLE 4
session-id, behavior-state-features, label
{{“session-id” : “192. 168. 122. 106_0:192. 168. 122.255:138.0:tcp”,
“behavior-state” : “1)|−1*)|-a*)|-”, “label”: “normal”},
{“session-id” : “192. 168.122. 103_0:192.168.122.3:0.0:arp”,
“behavior-state”: “2@-~”, “label”: “abnormal”}}

Next, the anomaly behavior learning process 144 generates input data for self-learning by combining learning-purpose behavior feature data generated by the detection-purpose behavior feature generation process 120 with abnormal learning-purpose behavior feature data archived in the cache DB 151.

The anomaly behavior learning process 144 generates a new second detection model 131-2 by learning the generated input data for self-learning based on a behavior learning algorithm. Here, various algorithms may be used as an available behavior learning algorithm.

Next, the anomaly behavior detection process 130 may mainly perform two operations.

That is, the anomaly behavior detection process 130 may predict, using the existing first detection model 131-1, whether a behavior in the behavior feature data input from the detection-purpose behavior feature generation process 120 is anomaly while operating in the detection mode, and may report the result of the prediction to the control/log analysis system 20.

Furthermore, the anomaly behavior detection process 130 may replace the existing first detection model 131-1 with the new second detection model 131-2 as a detection model replacement event is received from the anomaly behavior learning process 144 while driving and operating in the self-learning mode, and thereafter may switch the current state from the state of the self-learning mode to a stop state.

Finally, the control/log analysis system 20 receives the report of the detection result from the self-learning-based intrusion detection apparatus 100 and performs a function of utilizing the detection result for analyzing and monitoring.

The malware DB 12 is a kind of archive DB, which labels the NetFlow samples of the network input data of collected malware and learning-purpose behavior feature data of the detection-purpose behavior feature generation process 120 corresponding to the NetFlow sample with normal/abnormal states, and then manages the labeled data. In the future, when the self-learning-based intrusion detection apparatus 100 is deployed in an operating environment and is initialized to boot, the labeled data may be loaded into the cache DB 151 and may be used as abnormal data for self-learning.

Next, an operation in which the processes of the self-learning-based intrusion detection apparatus 100 according to the embodiment interact with the in-memory DB 150 including a Pub/Sub server function will be described in detail below.

FIG. 2 is a diagram for explaining an example of event channel subscription and event publication between processes in a self-learning-based intrusion detection apparatus according to an embodiment.

Referring to FIG. 2, a first process may be a process which desires to be provided with a self-learning-related event, and a second process may be a process which provides related data together with an event.

Therefore, the first process may subscribe (1) to event channel CH_A, through which an event is desired to be provided, in the Pub/Sub server of the in-memory DB 150, and may wait in a CH_A event queue. When the second process publishes (2) an event including related data to the event channel CH_A of the in-memory DB 150, the first process may get data (3) from the queue of the event channel CH_A.

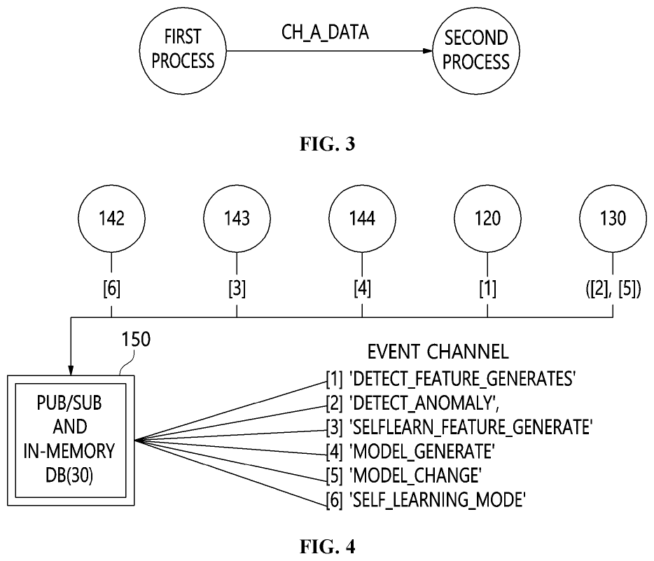

FIG. 3 is a conceptual diagram for explaining state transitions between the processes of a self-learning-based intrusion detection apparatus according to an embodiment.

Referring to FIG. 3, a second process publishes an event including related data to event channel CH_A, and transitions the operating state of the self-learning-based intrusion detection apparatus to the first process. The first process may read the published event data from channel CH_A, and may process a self-learning function in the corresponding state.

FIG. 4 is a diagram for defining publish/subscribe (Pub/Sub) event channels subscribed by the processes of a self-learning-based intrusion detection apparatus according to an embodiment.

Referring to FIG. 4, the total number of Pub/Sub event channels subscribed by the processes of the self-learning-based intrusion detection apparatus 100 according to the embodiment may be 6.

That is, after subscribing to the event channel of the self-learning mode (self_learning_mode) [6], the auto-labeling process 142 receives data from the corresponding event queue, and then processes the self-learning mode.

After subscribing to the event channel of self-learning feature generation (selflearn_feature_generate) [3], the learning-purpose behavior feature generation process 143 receives data from the corresponding event queue, and then generates self-learning features.

After subscribing to the event channel of model generation (model_generate) [4], the anomaly behavior learning process 144 receives data from the corresponding event queue, and then processes a self-learning mode.

After subscribing to the event channel of feature generation (detect_feature_generate) [1], the detection-purpose behavior feature generation process 120 receives data from the corresponding event queue, and then processes a self-learning mode.

After subscribing to the event channel of an anomaly detection channel (detect_anomaly) [2] or the event channel of model change (model_change) [5], the anomaly behavior detection process 130 receives data from the corresponding event queue for each channel, and then processes a given function.

The self-learning-based intrusion detection apparatus 100 according to the embodiment performs the detection mode operation and the self-learning mode operation using the above-described Pub/Sub server function. Here, the self-learning-based intrusion detection apparatus 100 may be operated while transiting a total of 12 states.

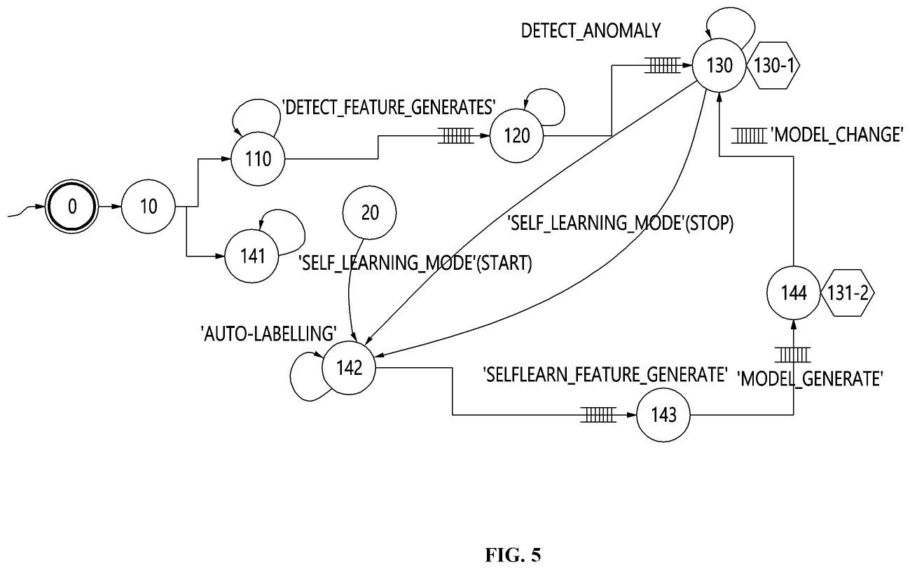

FIG. 5 is a diagram for explaining the state transition process of the self-learning-based intrusion detection apparatus according to an embodiment.

Referring to FIG. 5, the self-learning-based intrusion detection apparatus 100 according to an embodiment may be operated while transiting states between processes.

First, in a state detection mode, the self-learning-based intrusion detection apparatus 100 may be operated while transiting states in the order of initial booting (0), network traffic input (10), flow processing (110), signature processing (141), feature generation (120), and detection (130).

Also, in the self-learning mode, the self-learning-based intrusion detection apparatus 100 may be operated while transiting the states in the order of learning start (130, 20), auto-labeling (142), feature generation (143), learning modeling (144), model change (replacement) (130), and learning termination (130).

Here, the self-learning mode may start as the anomaly behavior detection process 130 or the control/log analysis system 20 publishes a self-learning mode (“self_learning_mode”, “Start”) event and transits the state to the auto-labeling process 142.

Thereafter, the state may make a transition in the order of the auto-labeling process 142, the learning-purpose behavior feature generation process 143, the anomaly behavior learning process 144, and the anomaly behavior detection process 130, and each process may perform a function assigned to the corresponding state.

By means of this, after the self-learned second detection model 131-2 is generated and the first detection model 131-1 of the anomaly behavior detection process 130 is replaced with the new second detection model 131-2, a self-learning mode (“self_learning_mode”, “Stop”) event is published to transit to the state of the auto-labeling process 142, thus completing the operation of the self-learning function.

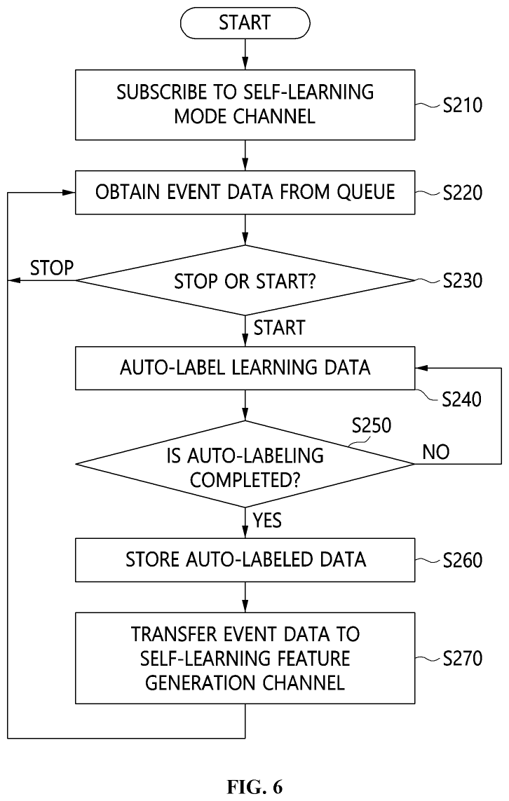

FIG. 6 is a flowchart for explaining a learning data auto-labeling process according to an embodiment.

Here, although a self-supervised learning scheme may be used as a self-learning scheme, the present disclosure is not limited thereto.

The self-learning-based intrusion detection apparatus 100 labels input data 10 by itself while performing a detection mode, and uses the labeled input data for learning.

Here, auto-labeling refers to a process of determining the behavior of network input data to the self-learning-based intrusion detection apparatus 100, and generates a normal label or an abnormal label.

Therefore, when the network input data 10 is received, the input processing process 110 processes labeling such a way that data is labeled with ‘normal’ data corresponding to an initial value and the auto-labeling process 142 changes the label of data detected as an attack to ‘anomaly’ data.

Referring to FIG. 6, when the auto-labeling process 142 is driven, the auto-labeling process 142 subscribes to a self-learning mode channel in the Pub/Sub server (Ch=subscribe (“self learning_mode”)) at step S210, and then waits in the corresponding queue for an event to occur.

Thereafter, when a self-learning mode (self_learning_mode) event is published, the auto-labeling process 142 obtains input data (IN_DATA=“self_learning_mode”.get_messgaeo) from the waiting queue at step S220.

Here, the input data IN_DATA may be composed of three attributes {operation, volume, period}. Here, the operation may be a variable indicating whether the operating state of the self-learning mode starts or stops, the volume may be a variable indicating the amount (volume) of learning data to be generated (e.g., auto-labeled ten million flows), and the period may be a variable indicating the period of learning data (e.g., data obtained for three days).

In the auto-labeling process 142, the operation variable value of the input data IN_DATA is determined at step S230.

When it is determined at step S230 that a value indicating operation stop is assigned to the operation variable of the input data IN_DATA, the auto-labeling process 142 returns to step S220 of waiting for a new event to occur.

On the other hand, when it is determined at step S230 that a value indicating operation start is assigned to the operation variable of the input data IN_DATA, the auto-labeling process 142 generates auto-labeled learning data autolabelled_dataset using both flow data INPUT1, stored in the in-memory DB 150 by the input processing process 110, and a signature detection log INPUT2, stored by the signature-based detection process 141, at step S240.

Here, step S240 may be repeated until an auto-labeling completion condition is satisfied at step S250.

Here, the auto-labeling completion condition may include the case where the volume value of the input data IN_DATA is equal to or greater than the volume value of the auto-labeled entire data or the case where the period value of the input data IN_DATA is equal to or greater than the period value of the auto-labeled entire data.

Meanwhile, the auto-labeling process will be described in detail below.

First, through the use of the communication session identifier <src_addr, dst_addr, src_port, dst_port, dst_port> of the flow data of the input processing process 110, the signature detection log of the signature-based detection process 141 matching the communication session identifier is found. When “msg” and “priority”, as the attributes of the detected log, match an attack, ‘abnormal’ data is assigned to the label of the corresponding input data. When there are one or more pieces of flow data having the same identifier, target data to be auto-labeled may be determined based on the timestamp of a log identified as an abnormal log.

Next, the auto-labeled data may be stored in the in-memory DB 150, and the storage position and search information thereof may be assigned to output data OUT_DATA at step S260. The following Table 5 shows an example of auto-labeled flow data.

TABLE 5

{“ts”: “1667450568044.537”, “dur”: “0.000000”, “saddr”: “10.20.210.10”,
“sport”: “123”, “daddr”: “10.30.213.244”, “dport”: “123”, “proto”: “udp”,
“origstate”: “INT”, “state”: “NotEstablished”, “pkts”: “1”, “allbytes”: “90”,
“spkts”: “1”, “sbytes”: “90”, “appproto”: “”, “label”: “abnormal”,
“snort_severity”: “1”, “snort_classType”: “ trojan-activity ”,
“snort_detectionType”: “ Malware, C&C, DoS Detection ”, “snort_msg”:
“INDICATOR-COMPROMISE DNS request for known malware sinkhole
domain iuqerfsodp9ifjaposdfjhgosurijfaewrwergwea.com - WannaCry”,
“snort_detectionTime”: “1667450565123.537”, “suricata_severity”: “1”,
“suricata_classType”: “trojan-activity”, “suricata_detectionType”:
“Malware, C&C, DoS Detection”, “suricata_msg”: “A Network Trojan was
detected”, “suricata_detectionTime”: “1667450566111.537”}

Through the above-described steps 210 to 260, when auto-labeling of data to be self-learned is terminated, that is, when the preparation of the input data to be self-learned is completed, the auto-labeling process 142 publishes a self-learning feature generation event including the output data OUT_DATA (Publish(“selflearn_feature_generate”, jasom.dumps(OUT_DATA)) at step S270. Thereafter, the process returns to step S220 of waiting for initial self-learning to start.

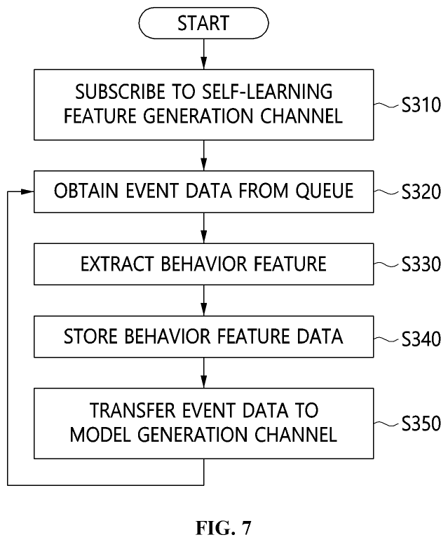

FIG. 7 is a flowchart for explaining a self-learning-purpose behavior feature generation process according to an embodiment.

Referring to FIG. 7, the learning-purpose behavior feature generation process 143 subscribes to a self-learning feature generation channel (Ch=subscribe(“selflearn_feature_generate”) at step S310, and waits in the corresponding queue for an event to occur.

As a self-learning feature generation event occurs, the learning-purpose behavior feature generation process 143 obtains data input to the corresponding queue (IN_DATA=“selflearn_feature_generate”.get_messageo) at step S320.

Thereafter, the learning-purpose behavior feature generation process 143 extracts the auto-labeled learning data stored in the in-memory DB 150 using information included in the input data IN_DATA, and then generates a behavior feature dataset feature_dataset at step S330. For example, the feature dataset may be {“session-id”: “192.168.122.106_192.168.122.255:138.0:tcp”, “behavior-state”:“1)-1*)-a*-” }.

Here, various behavior feature generation algorithms may be used. Further, an algorithm used when an initial detection model 131-1 is developed may be utilized.

Next, the learning-purpose behavior feature generation process 143 stores the generated behavior feature dataset in the in-memory DB 150, and assigns the storage position and search information thereof to output data OUT_DATA (OUT_DATA=save_DB(Feature_dataset) at step S350.

Thereafter, the learning-purpose behavior feature generation process 143 publishes a model generation event including the output data OUT_DATA (Publish(“model_generate”, jasom.dumps(OUT_DATA)) at step S350. Thereafter, the learning-purpose behavior feature generation process 143 waits in a self-learning feature generation queue for a new event to occur.

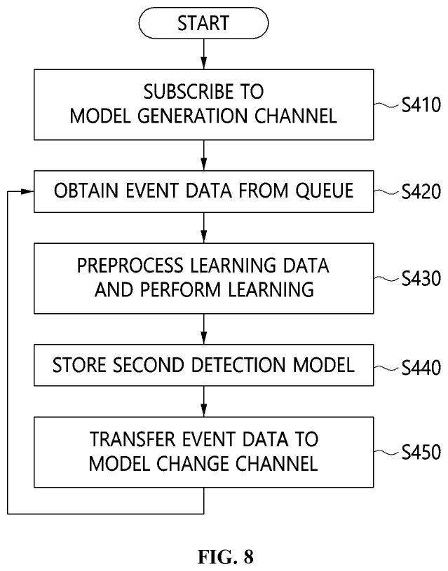

FIG. 8 is a flowchart for explaining an anomaly behavior learning and model generation process according to an embodiment.

Referring to FIG. 8, the anomaly behavior learning process 144 subscribes to a model generation channel (Ch=subscribe (“model_generate”)) at step S410, and waits in the corresponding queue for an event to occur.

As a model generation event is published, the anomaly behavior learning process 144 obtains data input to the corresponding queue (IN_DATA=“model_generate”.get_messageo) at step S420.

Here, the obtained data may be information necessary to retrieve a learning-purpose behavior feature dataset from the in-memory data DB 150.

Therefore, the anomaly behavior learning process 144 retrieves the learning-purpose behavior feature dataset stored in the in-memory DB 150 using information included in the input data IN_DATA, generates self-learning input data by preprocessing the retrieved behavior feature dataset, and generates a new detection model 131-2 using a learning algorithm at step S430.

Next, the anomaly behavior learning process 144 stores in the generated new detection model (second detection model) in the in-memory DB 150, and assigns the storage position thereof and parameter information required for the use of the model to the output data OUT_DATA (OUT_DATA={“model_path”:“c\”, “model_max_length”:0000}) at step S350.

Thereafter, the anomaly behavior learning process 144 publishes a model change event including the output data OUT_DATA (Publish(“model_change”, jasom.dumps(OUT_DATA)) at step S450. Next, the anomaly behavior learning process 144 waits in a model generation queue for a new event to occur.

Meanwhile, the present disclosure may include two embodiments as a method for starting a self-learning function.

First, according to an embodiment, as a predetermined condition is satisfied during the operation of detecting an anomaly behavior by the anomaly behavior detection process 130, the self-learning function may start.

Also, according to another embodiment, the self-learning function may start under a policy-based operational determination by the control/log analysis system 20 that the improvement or relearning of a detection model is required.

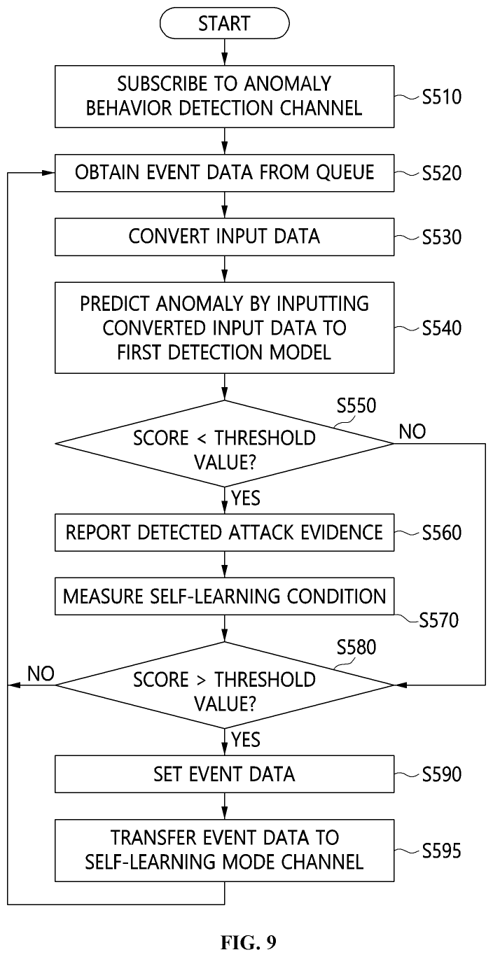

FIG. 9 is a flowchart for explaining an anomaly behavior detection and self-learning start process according to an embodiment.

Referring to FIG. 9, the anomaly behavior detection process 130 subscribes to an anomaly behavior detection channel (Ch=subscribe (“detect_anomaly”) at step S510, and waits in the corresponding queue for an event to occur.

As a self-learning feature generation event is published, the anomaly behavior detection process 130 obtains data input to the corresponding queue (IN_DATA=“detect_anomaly”.get_messageo) at step S520.

Next, the anomaly behavior detection process 130 retrieves behavior feature data stored in the in-memory DB 150 using information included in the input data IN_DATA, and converts the behavior feature data into the input data of the first detection model 131-1 (in_data=Convert(IN_DATA)) at step S530.

Thereafter, the anomaly behavior detection process 130 predicts an anomaly by inputting the converted data in_data to the first detection model 131-1, and then calculates a score anomaly_score at step S540.

Thereafter, the anomaly behavior detection process 130 determines whether the anomaly score anomaly_score is less than a preset threshold value at step S550.

When it is determined at step S550 that the anomaly score anomaly_score is not less than the preset threshold value, the anomaly behavior detection process 130 reports a detected attack evidence at step S560.

On the other hand, when it is determined at step S550 that the anomaly score anomaly_score is less than the preset threshold value, the anomaly behavior detection process 130 determines that the current state is a normal state in which no attacks are detected, and proceeds to step S570.

Thereafter, the anomaly behavior detection process 130 measures a self-learning score selflearning_Score by executing an algorithm of measuring whether a self-learning condition is satisfied at step S570. Here, accuracy deterioration, occurrence of an excessive false positive rate, etc. may be measured.

The anomaly behavior detection process 130 may determine whether the self-learning score selflearning_Score is greater than a self-learning threshold value at step S580.

When it is determined at step S580 that the self-learning score selflearning_Score is greater than the self-learning threshold value, the anomaly behavior detection process 130 determines that the improvement of performance is required due to the deterioration of performance of the first detection model 131-1, generates learning start event data, and assigns the learning start event data to the output data OUT_DATA (OUT_DATA={“operation=“Start””, “volume”=xx, “period”=xx}) at step S590.

Thereafter, the anomaly behavior detection process 130 publishes a self-learning mode event including the output data OUT_DATA (Publish(“self learning_mode”, jasom.dumps(OUT_DATA)) at step S595. Next, the anomaly behavior detection process 130 waits in an anomaly detection queue for a new event to occur.

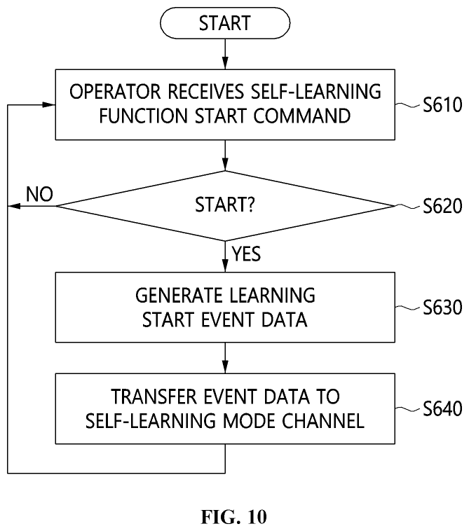

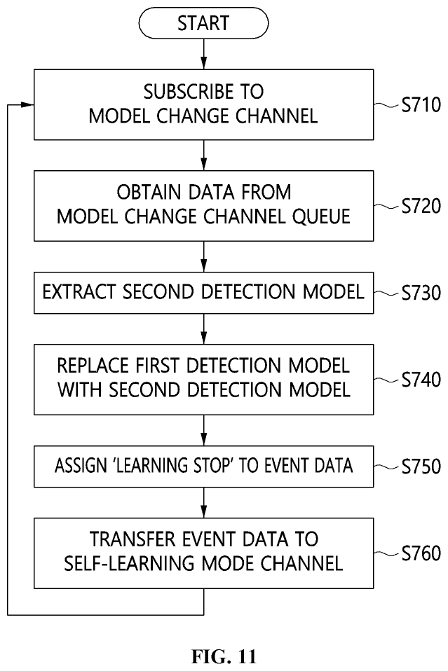

FIG. 10 is a flowchart for explaining a self-learning start process performed by a control/log analysis system according to an embodiment.

Referring to FIG. 10, the operator of the control/log analysis system 20 receives a self-learning function start command (IN_DATA={operation, volume, period}) at step S610.

When “operation” in the input data is set to ‘start’ at step S620, the control/log analysis system 20 generates learning start event data and assigns the learning start event data to the output data OUT_DATA (OUT_DATA={“operation=“Start””, “volume”=xx, “period”=xx}) at step S630.

Thereafter, the control/log analysis system 20 publishes a self-learning mode event including the output data OUT_DATA (Publish(“self learning_mode”, jasom.dumps(OUT_DATA)) at step S640.

FIG. 11 is a flowchart for explaining a detection model replacement and self-learning stop process according to an embodiment.

Referring to FIG. 11, the anomaly behavior detection process 130 subscribes to a model change channel (Ch=subscribe (“model_change”) at step S710, and waits in the corresponding queue for an event to occur.

As a model change event is published, the anomaly behavior detection process 130 obtains data input to the corresponding queue (IN_DATA=“model_change”.get_messageo) at step S720.

Next, the anomaly behavior detection process 130 extracts the second detection model using information included in the input data IN_DATA at step S730.

Thereafter, the anomaly behavior detection process 130 replaces the first detection model with the second detection model at step S740.

Then, the anomaly behavior detection process 130 assigns ‘learning stop’ to the output data OUT_DATA (OUT_DATA=“Stop”) at step S750.

Thereafter, the anomaly behavior detection process 130 publishes a self-learning mode event including the output data OUT_DATA (Publish(“self learning_mode”, jasom.dumps(OUT_DATA)) at step S760. Next, the anomaly behavior detection process 130 waits in an anomaly detection queue for a new event to occur.

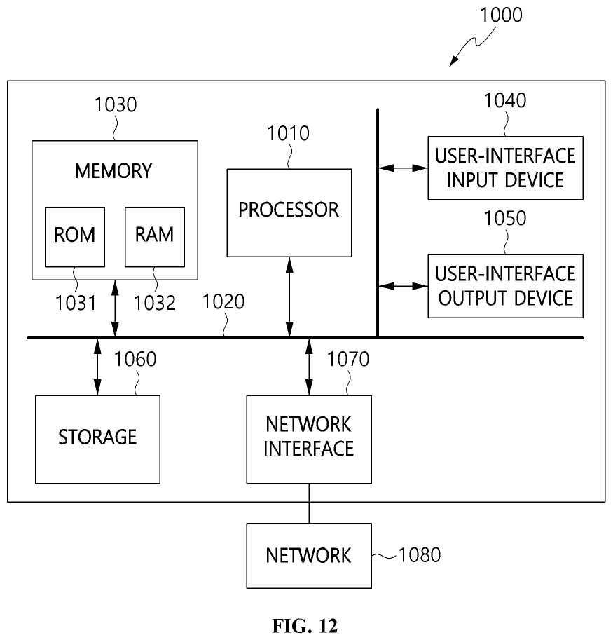

FIG. 12 is a diagram illustrating the configuration of a computer system according to an embodiment.

A self-learning-based intrusion detection apparatus 100 according to an embodiment may be implemented in a computer system 1000 such as a computer-readable storage medium.

The computer system 1000 may include one or more processors 1010, memory 1030, a user interface input device 1040, a user interface output device 1050, and storage 1060, which communicate with each other through a bus 1020. The computer system 1000 may further include a network interface 1070 connected to a network 1080. Each processor 1010 may be a Central Processing Unit (CPU) or a semiconductor device for executing programs or processing instructions stored in the memory 1030 or the storage 1060. Each of the memory 1030 and the storage 1060 may be a storage medium including at least one of a volatile medium, a nonvolatile medium, a removable medium, a non-removable medium, a communication medium, and an information delivery medium. For example, the memory 1030 may include Read-Only Memory (ROM) 1031 or Random Access Memory (RAM) 1032.

Further, the above-described apparatus 100 performs a self-learning-based intrusion detection method according to an embodiment.

The self-learning-based intrusion detection apparatus 100 according to the embodiment may include detecting an anomaly behavior in network traffic based on a first detection model, and as a self-learning event is published, generating a second detection model through self-learning in parallel with detecting the anomaly behavior, wherein detecting the anomaly behavior includes, as the second detection model is generated, replacing the first detection model with the second detection model, and thereafter detecting the anomaly behavior in the network traffic.

Here, detecting the anomaly behavior may include converting network input data into NetFlow data, extracting detection-purpose behavior feature data from the NetFlow data, and predicting whether a behavior in the extracted behavior feature data is anomalous, based on the first detection model.

Here, detecting the anomaly behavior may further include detecting the signature of the NetFlow data.

Here, generating the second detection model may include auto-labeling the NetFlow data as to whether the NetFlow data is normal or abnormal as a self-learning mode starts, generating learning-purpose behavior feature data of auto-labeled NetFlow data, and generating the second detection model by performing learning based on the learning-purpose behavior feature data.

Here, predicting whether the behavior is anomalous may include measuring a self-learning score based on at least one of accuracy of a detection result based on the first detection model or a false positive rate, or a combination thereof, and when the self-learning score is greater than a preset threshold value, starting the self-learning mode.

Here, the start of the self-learning mode may be performed in compliance with a command from a manager through an external control/analysis system.

Here, predicting whether the behavior is anomalous may further include as the second detection model is generated, replacing the first detection model with the second detection model, and stopping the self-learning mode.

Although the embodiments of the present disclosure have been disclosed with reference to the attached drawing, those skilled in the art will appreciate that the present disclosure can be implemented in other concrete forms, without changing the technical spirit or essential features of the disclosure. Therefore, it should be understood that the foregoing embodiments are merely exemplary, rather than restrictive, in all aspects.

According to an embodiment, it is possible to minimize the cost of improving the learning model, which is essentially needed in a process of operating and maintaining, by improving an intrusion detection model by self-learning operating environment data at run-time in a manner that minimizes human intervention.

What is claimed is:

1. A self-learning-based intrusion detection apparatus, comprising:
a memory configured to store at least one program; and
a processor configured to execute the program,
wherein the program is configured to perform:
detecting an anomaly behavior in network traffic based on a first detection model; and
as a self-learning event is published, generating a second detection model through self-learning in parallel with detecting the anomaly behavior, and
wherein the program is configured to perform, as the second detection model is generated,
in detecting the anomaly behavior, replacing the first detection model with the second detection model, and thereafter detecting the anomaly behavior in the network traffic.

2. The self-learning-based intrusion detection apparatus of claim 1, further comprising:
an in-memory database (DB) including a function of a Publish/Subscribe (Pub/Sub) server of performing event channel subscribe and event publish messaging,
wherein a first process subscribes to a certain event channel in the Pub/Sub server and thereafter waits in a queue of the event channel, and
wherein a second process transmits event data to the queue of the corresponding event channel as a certain event is published.

3. The self-learning-based intrusion detection apparatus of claim 2, wherein the program is configured to further perform:
in detecting the anomaly behavior, converting network input data into NetFlow data;
extracting detection-purpose behavior feature data from the NetFlow data; and
predicting whether a behavior in the extracted behavior feature data is anomalous, based on the first detection model.

4. The self-learning-based intrusion detection apparatus of claim of claim 3, wherein the program is configured to further perform:
in detecting the anomaly behavior, detecting a signature in the NetFlow data.

5. The self-learning-based intrusion detection apparatus of claim 4, wherein the program is configured to further perform:
in generating the second detection model, auto-labeling the NetFlow data as to whether the NetFlow data is normal or abnormal as a self-learning mode starts;
generating learning-purpose behavior feature data of auto-labeled NetFlow data; and
generating the second detection model by performing learning based on the learning-purpose behavior feature data.

6. The self-learning-based intrusion detection apparatus of claim 5, wherein the program is configured to further perform:
in auto-labeling the NetFlow data, subscribing to a self-learning mode channel in the Pub/Sub server and waiting in a queue;
when a self-learning mode event is published, obtaining input data from the queue;
generating auto-labeled learning data using the NetFlow data, retrieved from the in-memory DB based on the input data, and a signature detection log;
storing the auto-labeled learning data in the in-memory DB, and assigning a storage position and search information thereof to output data; and
publishing a self-learning feature generation event including the output data.

7. The self-learning-based intrusion detection apparatus of claim 6, wherein the input data is defined as variables including information of whether an operating state of the self-learning mode starts or stops, a volume of learning data, and a collection period of learning data.

8. The self-learning-based intrusion detection apparatus of claim 5, wherein the program is configured to further perform:
in generating the learning-purpose behavior feature data, subscribing to a self-learning feature generation channel and waiting in a queue;
when a self-learning feature generation event is published, obtaining input data from the queue;
generating a behavior feature dataset from auto-labeled learning data retrieved from the in-memory database based on the input data;
storing the generated behavior feature dataset in the in-memory database, and assigning a storage position and search information thereof as output data; and
publishing a model generation event including the output data.

9. The self-learning-based intrusion detection apparatus of claim 5, wherein the program is configured to further perform:
in generating the second detection model, subscribing to a model generation channel and waiting in a queue;
as a model generation event is published, obtaining data input to the queue;
generating self-learning input data by preprocessing a learning-purpose behavior feature dataset retrieved from the in-memory database based on the input data, and generating a new second detection model using a learning algorithm;
storing the generated second detection model and allocating a storage position thereof and parameter information required for use of the model to output data; and
publishing a model change event including output data.

10. The self-learning-based intrusion detection apparatus of claim 6, wherein the program is configured to further perform:
in predicting whether the behavior is anomalous, measuring a self-learning score based on at least one of accuracy of a detection result based on the first detection model or a false positive rate, or a combination thereof; and
when the self-learning score is greater than a preset threshold value, publishing a learning mode event.

11. The self-learning-based intrusion detection apparatus of claim 6, wherein the self-learning mode event is published from an external control/log analysis system.

12. The self-learning-based intrusion detection apparatus of claim 9, wherein the program is configured to further perform:
in predicting whether the behavior is anomalous, subscribing to a model change channel and waiting in a queue;
as a model change event is published, obtaining data input to the queue;
extracting the second detection model using information included in the input data, and replacing the first detection model with the second detection model; and
publishing a self-learning mode event by assigning learning stop to the output data.

13. A self-learning-based intrusion detection method, comprising:
detecting an anomaly behavior in network traffic based on a first detection model; and
as a self-learning event is published, generating a second detection model through self-learning in parallel with detecting the anomaly behavior,
wherein detecting the anomaly behavior comprises:
as the second detection model is generated, replacing the first detection model with the second detection model, and thereafter detecting the anomaly behavior in the network traffic.

14. The self-learning-based intrusion detection method of claim 13, wherein detecting the anomaly behavior comprises:
converting network input data into NetFlow data;
extracting detection-purpose behavior feature data from the NetFlow data; and
predicting whether a behavior in the extracted behavior feature data is anomalous, based on the first detection model.

15. The self-learning-based intrusion detection method of claim 14, wherein detecting the anomaly behavior further comprises:
detecting a signature of the NetFlow data.

16. The self-learning-based intrusion detection method of claim 15, wherein generating the second detection model comprises:
auto-labeling the NetFlow data as to whether the NetFlow data is normal or abnormal as a self-learning mode starts;
generating learning-purpose behavior feature data of auto-labeled NetFlow data; and
generating the second detection model by performing learning based on the learning-purpose behavior feature data.

17. The self-learning-based intrusion detection method of claim 16, wherein predicting whether the behavior is anomalous comprises:
measuring a self-learning score based on at least one of accuracy of a detection result based on the first detection model or a false positive rate, or a combination thereof; and
when the self-learning score is greater than a preset threshold value, starting the self-learning mode.

18. The self-learning-based intrusion detection apparatus of claim 16, wherein the start of the self-learning mode is performed in compliance with a command from a manager through an external control/analysis system.

19. The self-learning-based intrusion detection method of claim 17, wherein predicting whether the behavior is anomalous further comprises:
as the second detection model is generated, replacing the first detection model with the second detection model; and
stopping the self-learning mode.

20. A self-learning-based intrusion detection apparatus, comprising:
an in-memory database (DB) including a function of a Publish/Subscribe (Pub/Sub) server of performing event channel subscribe and event publish messaging;
a memory configured to store at least one program; and
a processor configured to execute the program,
wherein the program is configured to perform:
in an anomaly behavior detection mode, converting network input data into NetFlow data;
detecting a signature of the NetFlow data;
extracting detection-purpose behavior feature data from the NetFlow data; and
predicting whether a behavior in the extracted behavior feature data is anomalous, based on a first detection model,
in a self-learning mode, as the self-learning mode starts, auto-labeling the NetFlow data as to whether the NetFlow data is normal or abnormal;
generating learning-purpose behavior feature data of auto-labeled NetFlow data; and
generating a second detection model by performing learning based on the learning-purpose behavior feature data,
wherein the self-learning mode and the anomaly behavior detection mode are performed in parallel for interconnection with the Pub/Sub server,
as the second detection model is generated, the first detection model is replaced with the second detection model.
